(19) United States
(12) Patent Application Publication
(10) Pub. No.: US 2010/0230022 A1
(43) Pub. Date: Sep. 16, 2010

(54) Tubeless tire having elliptical cylinder-shaped elastic members

(76) Inventor: Jong Kyung Kim, Daegu (KR)

Correspondence Address: JAMES C. WRAY, 1493 CHAIN BRIDGE ROAD, SUITE 300, MCLEAN, VA, 22101, US

(21) Appl. No.: 12/387,748

(22) Filed: May 7, 2009

(30) Foreign Application Priority Data
Mar. 12, 2009 (KR) 10-2009-0021080

(51) Int. Cl. B60C 7/00

(52) U.S. Cl. 152/310

(57) ABSTRACT

A tubeless tire is embedded with elliptical cylinder-shaped elastic members. The tubeless bicycle tire has a multiple number of elliptical cylinder-shaped elastic members arranged at regular intervals along the circular tubeless tire and extends through to sides of the tubeless tire. The major axis of each elastic member is fixed integrally with the tire member, being arranged in a radial direction toward a rotational axis of the tubeless tire. The tire is reinforced with elastic force of the elastic members. The tire does not excessively flatten by a load at the portion of the tire touching the road. After leaving the road, the tire restores its original form swiftly by combined elastic force of the tire and elastic rebound of the elastic members. The tire does not flatten again before it restores its original form. The tire produces a safe and longer life free from puncture.

### BACKGROUND OF THE INVENTION

This application claims the benefit of Korean Application No. 10-2009-0021080 filed Mar. 12, 2009.

### Technical Field

The present invention relates to a tubeless tire integrally embedded with elliptical cylinder-shaped elastic members.

### Background Art

There have been conventional bicycle tires such as one with a tube inside into which air is pumped giving it elasticity to absorb shock and to bring forth a comfortable bicycle ride. Another type is a tubeless tire made of an elastic rubber or an elastic synthetic rubber.

Recently, puncture-free tubeless tires with narrower tread and thinner tire for lighter weight of the bicycle have come into fashion.

### PARTICULARS OF THE INVENTION

### Technical Problem

A tubeless tire for a bicycle is formed with an elastic rubber or an elastic synthetic rubber. Some have independent foams dispersed in the tire member for pliable elasticity and others are made only of elastic material.

If one rides a bicycle on the road with a tubeless tire mounted on the rims of the wheels, as shown in FIG. 9X, the portion of the tire member t that does not touch the road maintains the original form by its elasticity. However, as shown in FIG. 9Y, the portion of the tire member t that touches the road is pressed between the rim r of the wheel and the road E by the load of the bicycle. As a result, the thickness Th of the tire member shrinks and the width W of the tire member expands. Undoubtedly, part of the load is directed toward the circular direction of the tire. However, as there is little room for deformation of the tire toward the circular direction of the tire, the tire deformation occurs mostly sideways in the tire. As soon as the portion of the tire member t that touches the road leaves the road, the tire member portion returns to the original form from the deformed state by the elastic force of the tire member.

In this way, when one rides a bicycle, each portion of the circularly mounted tire repeats the operation of deformation and restoration as it touches and leaves the road. As this operation of deformation and restoration is repeated over a long period of time, the tire member has to undergo cumulative elastic fatigue in its material, resulting in delays in the operation of restoration from deformation. This leads to the repetition of the tire member being pressed before it recovers from the flattened position, resulting in the situation where the tire member t is reduced to a plate-like form as shown in FIG. 9Z.

As long as the operation of deformation and restoration of the tire member is repeated, the tire retains the cushion function of absorbing the shock coming from running the road by the elasticity of the tire member. However, if the tire member turns flat, it loses its elastic cushion almost entirely. As a result, the tire loses its shock absorbing function, bringing about discomfort in riding. This situation leads to replacement of tires with new ones. As the replacement of tires occurs rather frequently, the cost of tire replacements becomes far from negligible.

### SUMMARY OF THE INVENTION

### Technical Solution

The objective of the present invention is to provide a tubeless tire embedded with elliptical cylinder-shaped elastic members capable of reducing elastic fatigue of a tubeless tire for a bicycle.

Another object of the present invention is to provide a new tubeless tire embedded with elliptical cylinder-shaped elastic members with reinforced elastic force. The tubeless tire for mounting on the rim of a bicycle has a multiple number of elliptical cylinder-shaped elastic members arranged at regular intervals along the circular tubeless tire in such a way as to open through both sides of the tubeless tire. The major axis of each elastic member, which is fixed integrally with the tire member, is arranged in a radial direction toward the rotation axis of the tubeless tire.

Another object of the present invention is to provide a tubeless tire embedded with elliptical cylinder-shaped elastic members that does not need frequent replacement of tires, with prolonged retention of elastic force of the tire with the reduction of elastic fatigue of the tubeless tire.

To attain the above-noted objectives, the present invention provides a tubeless tire for a bicycle having a multiple number of elliptical cylinder-shaped elastic members. The elastic members are arranged and fixed at regular intervals along the circular tire body, which is made of elastic rubber or elastic synthetic rubber, in such a way that the elastic members open through both sides of the tubeless tire. The major axis of each elastic member is arranged in a radial direction towards a rotation axis of the tubeless tire.

In the present invention, the elastic members are made of a material that is compatible with the rubber of the tire member and has stronger elasticity and is firmer than the rubber, such as, for instance, an elastic nylon resin or an elastic silicone resin. The sectional thickness of each elastic member is greater in the middle than in both edge portions. The outer diameter of the middle portion of each elastic member is greater than the outer diameter of the edge portions on either side. As a result, the elastic member is in the form of an elliptical cylinder with the middle portion of its peripheral surface sloping symmetrically toward both edges. The inner diameter of the elliptical through hole of the elastic member slopes a little expanding from the middle portion toward the edges

This construction of the elastic member has advantages in its function and manufacture.

In forming and manufacturing the elastic member, as the through hole of the elastic member slopes a little expanding from its interior toward its exterior, it is easy to separate the mold from the through hole of the elastic member after it is manufactured. Besides, when the tire is molded through a molding process, the elastic member can be arranged conveniently in the mold of the tire by inserting the elastic member onto the mold pins in the tire mold. Furthermore, it is easy to separate the mold and the mold pin of the tire from the elastic member after the tire is formed.

Moreover, as the middle portion of the elastic member with a greater outer diameter is firmly fixed in the tire member, the tire member and the elastic members are firmly fixed together and remain in that state. In addition, convex ridges or concave grooves or steps can be provided on the peripheral surface of the elastic members to enlarge the surface areas so as to further increase the firmness of connections between the tire member and the elastic member.

The tire in the present invention that is fixed to the rims of a bicycle wheels runs on the road with its tread touching the road. Portions with the elastic members embedded in the tire member and the portions of the tire member between the elastic members touch the road one after another.

When a portion of the tire where an elastic member is located touches the road, the tire is cushioned by the elasticity of the elastic member against the load of the bicycle. As the load of the bicycle is oriented toward the major axis of the elastic member, the through hole withstands collapse with the strong pressure-resistance of the elastic member in the form of an elliptical cylinder. Furthermore, as the elastic members are surrounded by the tire member, the elastic force of the elastic members reinforce that of the tire member.

Also, when the portion of the tire member between the elastic members touches the road, the tire member is elastically pressed by the load of the bicycle, deforming as it is flattened and expanding toward its sides. As that portion of the tire member leaves the road, it recovers its original shape swiftly by its own elastic force and by the reinforcement of the elastic rebound of the adjacent elastic members on both sides, and the elastic cushion of the tire is well maintained.

The reinforcement of the elastic force of the tire by the elastic members reduces the elastic fatigue of the tire, preventing the tire from becoming flat, and prolonging the life of the tire in good shape.

Besides, as the outer diameter of the middle portion of each elastic member is greater than the outer diameters of both of its edges, the elastic member is firmly fixed within the tire member. Therefore, even though the tire member repeats the process of deformation and restoration a great number of times, there is no likelihood of the elastic members being separated and falling out of the tire member. As the elastic member and the tire member augment their elastic force mutually, the tubeless tire in the present invention gives better tire cushion and longer life compared with the conventional simple tubeless tires.

### Effect of the Invention

The tubeless tire in the present invention has a multiple number of elliptical cylindrically-shaped elastic members arranged at regular intervals along the circular tubeless tire in such a way as to open through both sides of the tire. The major axis of each elastic member, which is fixed integrally with the tire member, is arranged in an axial direction toward the rotation axis of the tubeless tire. Therefore, the elastic force of the tire member of the tubeless tire and that of the elastic members are reinforced by each other to retain good cushioning of the tire.

Besides, even if the portion of the tire that touches the road is pressed by the load of the bicycle, the tire swiftly restores its original shape by the elastic rebound of the elastic members, preventing the situation where a flattened tire member is compressed again before it restores its original shape, thereby reducing the elastic fatigue and prolonging the life of the tubeless tire compared with conventional tubeless tires.

These and further and other objects and features of the invention are apparent in the disclosure, which includes the above and ongoing written specification, with the claims and the drawings.

Examples for embodiments of the invention are shown in the drawings and described in the detailed description.

### BRIEF DESCRIPTION OF THE DRAWINGS

FIG. 1 shows an embodiment of the present invention.

FIG. 2 is a partially cutaway perspective view of the tire of the present invention.

FIGS. 3A and 3B show an embodiment of the elastic member of the present invention. FIG. 3A is a perspective view of the elliptical cylinder-shaped elastic member.

FIG. 3B is a sectional view of the elastic member shown in FIG. 3A.

FIGS. 4A and 4B show another embodiment of the elastic member in the present invention.

FIG. 4A is a perspective view of the elastic member whose peripheral surface is formed with a plurality of steps. FIG. 4B is a sectional view of the elastic member shown in FIG. 4A.

FIG. 5 is a sectional view taken along line A-A of FIG. 3B and along line A′-A′ of FIG. 4B.

FIG. 6 is a view of the elastic member in the present invention illustrating how it is formed by molding.

FIGS. 7A-D illustrate how the elastic member in the present invention is embedded in the tubeless tire.

FIG. 7A illustrates how the elastic member is arranged between opposed mold pins of the mold in the tubeless tire.

FIG. 7B illustrates the elastic member inserted on the mold pins in the closed mold for the tubeless tire.

FIG. 7C illustrates how the tubeless tire is molded around the elastic member embedded therein.

FIG. 7D is a sectional view of the tubeless tire after the molding and manufacturing is completed.

FIG. 8 illustrates the elastic operation of the tubeless tire of the present invention in the portion touching the road.

FIG. 9X, Y and Z illustrate how a conventional tubeless tire is deformed by the load of the bicycle.

### DETAILED DESCRIPTION OF THE PREFERRED EMBODIMENTS

### KEY NUMERALS USED IN THE DRAWINGS

1: tire, 1a: tire member, 1b: body, 2: elastic member, 2f: peripheral surface, 2h: through hole, 2p: sloping step, 2s: inside perimeter surface

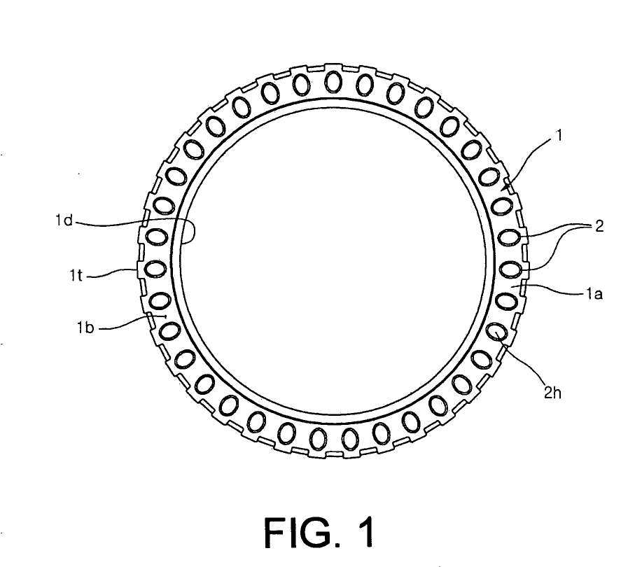

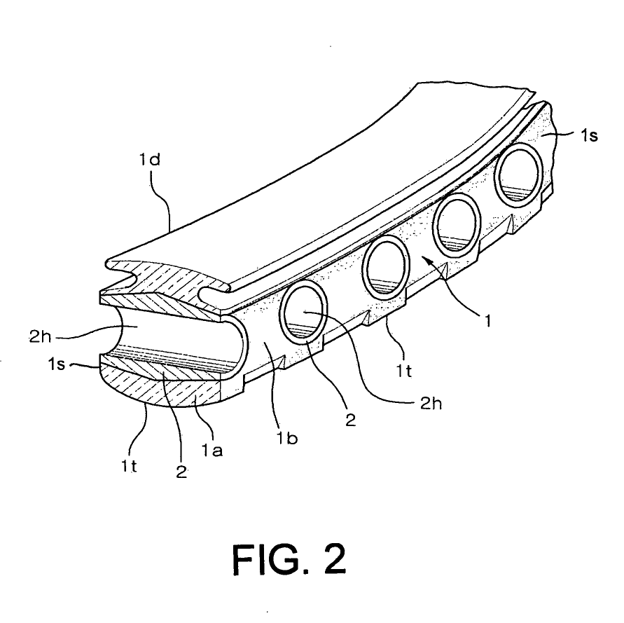

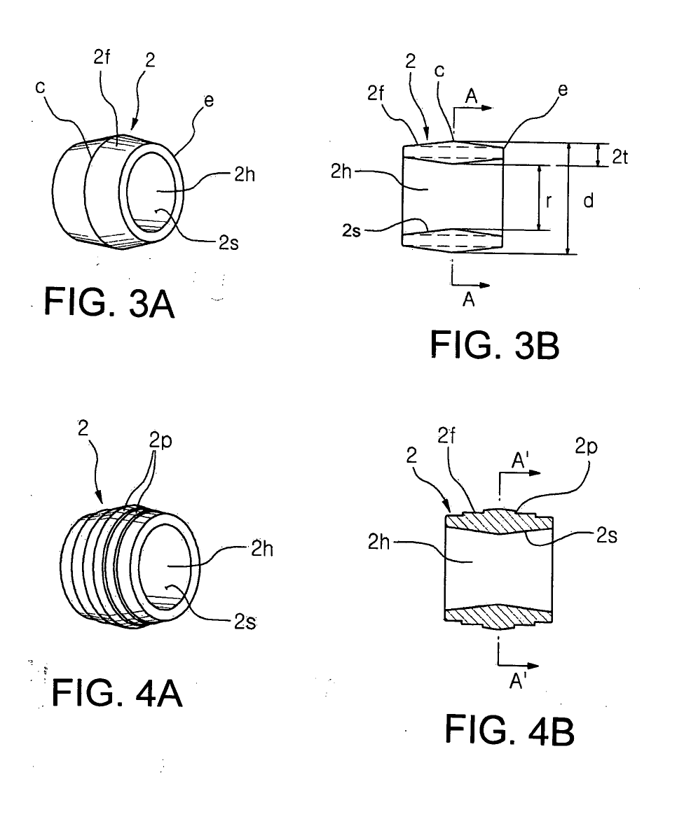

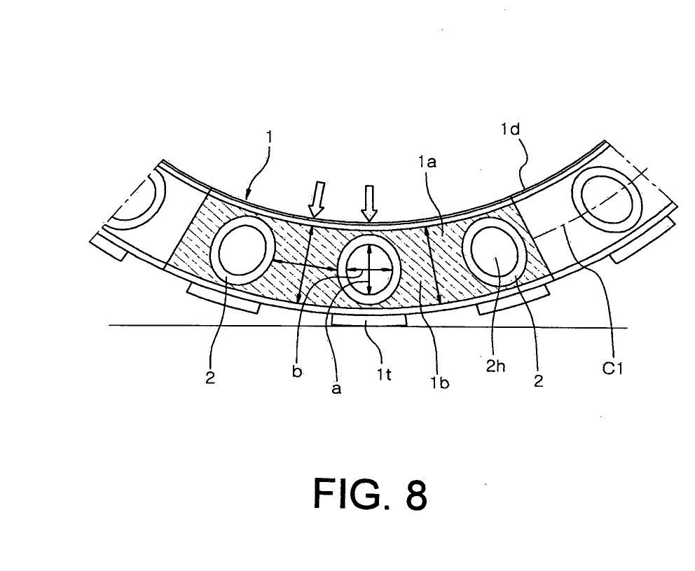

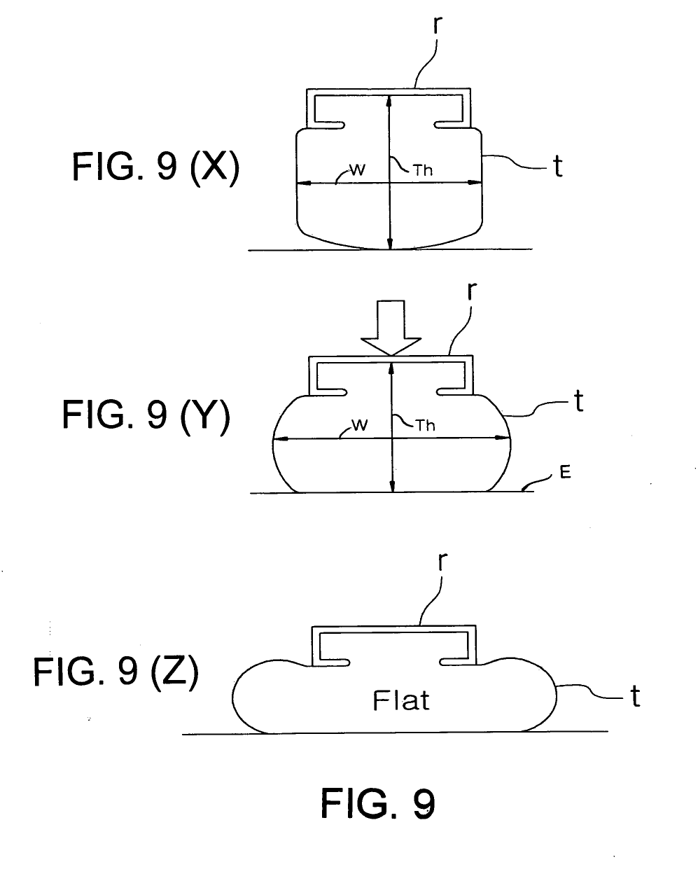

FIG. 1 is a side view of the bicycle tire in an embodiment of the present invention, and FIG. 2 is a partially cutaway perspective view of the tire in the present invention; and FIG. 3 shows an embodiment of the elastic member in the present invention. FIG. 8 shows multiple elastic members in a tire.

As shown in FIG. 1 and FIG. 2, in a tubeless tire 1 for a bicycle, a multiple number of elliptical cylinder-shaped elastic members 2 are arranged at regular intervals along a circular line C1 shown in FIG. 8 of the portion of the tire body 1b between the bead 1d and the tread 1t of the tubeless tire 1, which is made of an elastic rubber or an elastic synthetic rubber, in such a way as to open through both sides 1s of the tire body 1b. The major axis a (FIG. 8) of each elastic member 2, which is fixed integrally with the tire member 1a, is arranged in the direction of the radii extending toward the rotation axis of the tubeless tire 1.

As shown in FIGS. 1 and FIG. 2, each elastic member 2 has a through hole 2h extending from left to right and opening on both sides 1s of the body 1b of the tire 1.

In the present invention, the elastic member 2 is made of a material which is compatible with the rubber material of the tire member 1a and which has greater elasticity and firmness compared with rubber material, such as an elastic nylon resin or elastic silicone resin. And as shown in FIGS. 3A and 3B, the sectional thickness 2t of the elastic member 2 is relatively greater in the middle portion c than at the edges e on both sides, and the outer diameter d of the middle portion c of the elastic member 2 is greater than the outer diameters of the edges e on both sides. Therefore, the peripheral surface 2f of the elastic member 2 in its middle portion c is greater than at the edges e on both sides. Therefore, the peripheral surface 2f of the elastic member 2 makes an elliptical cylindrically-shaped form, sloping symmetrically from the middle portion toward the edges on both sides. Also, the elliptical through hole 2h of the elastic member 2 has an inside perimeter surface 2s whose inner diameter r enlarges a little sloping from the middle portion c toward the edges e.

In another embodiment of the elastic member, as shown in FIGS. 4A and 4B, a plurality of sloping steps 2p can be provided on the peripheral surface 2f of the elastic member to increase its surface area so as to enhance the firmness of its fixing within the tire member 1a. Also possible for employment is the classical method of providing convex ridges or concave grooves on the peripheral surface of the elastic member.

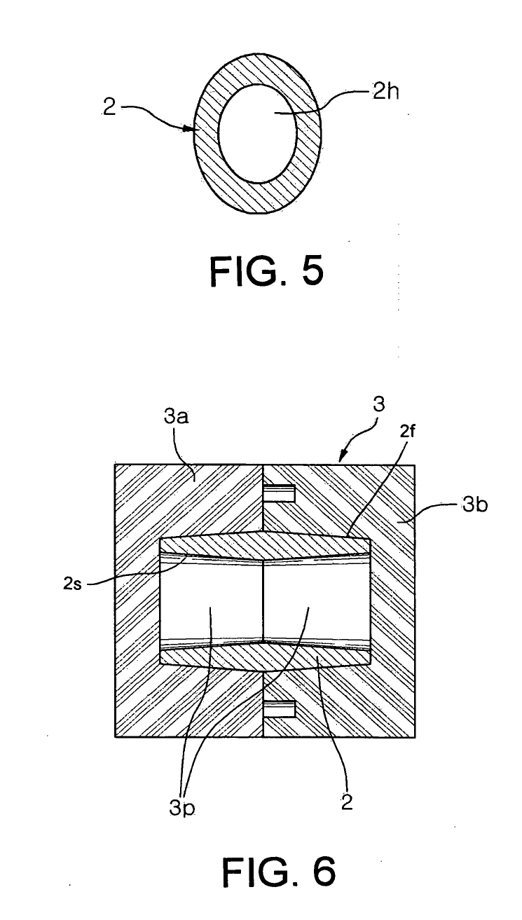

The through hole 2h of the elastic member 2 as shown by A-A arrow lines and by A′-A′ arrow lines in the sectional drawings of FIG. 3B and FIG. 4B, respectively, is an elliptical hole, as shown in FIG. 5. As shown in FIG. 8, the major axis a of the elliptical hole 2h is arranged in such a way as to be radially directed toward the rotation axis of the tire 1 so as to receive the load of the bicycle. The minor axis b of the elliptical hole is directed toward the circular direction C1 of the tire 1.

This construction of the elastic member 2 gives advantages in reinforcing the elastic force of the tire and convenience in manufacturing the tire.

In other words, for example in manufacturing the elastic members, as shown in FIG. 6, it is easy to shield the elastic member 2. The peripheral surface 2f of the elastic member 2 and the inside perimeter surface 2s of the through hole 2h each slopes from the middle portion toward the edges. It is easy to separate the parts of the mold 3 from the peripheral surface 2f, and the mold pins 3p from the through hole 2h of the elastic member 2. The elastic member 2 is molded by injecting the liquid of synthetic resin into the cavity of the mold 3 under the condition where the mold pins 3p for the through hole mounted in the female mold 3a and in the male mold 3b are pressed together.

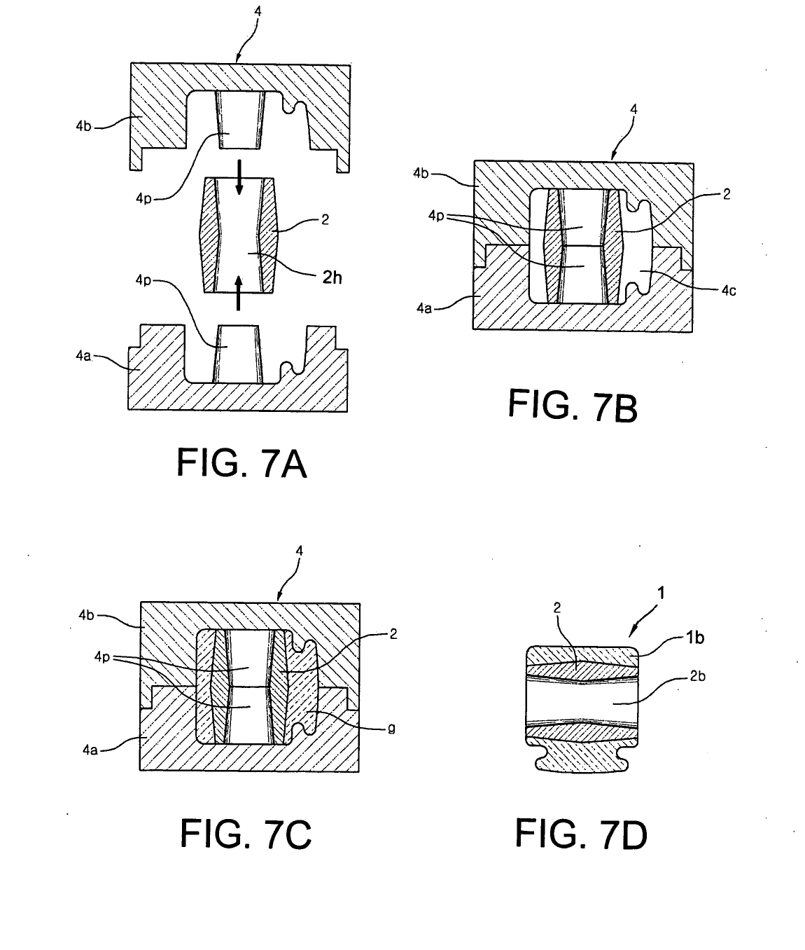

Likewise, in manufacturing a tire 1 by molding it with a mold 4, for example as shown in FIG. 7A, the elastic member 2 can be easily arranged in the mold 4 of the body 1b portion of the tire 1 by inserting the through hole 2h of the elastic member 2 onto the mold pin 4p of either the female mold 4a or the male mold 4b for the tire. As shown in FIG. 7B, after arranging all the elastic members 2 onto the mold pins 4p of the mold 4, the female mold 4a and the male mold 4b can be connected, forming the cavity 4c. As shown in FIG. 7C, the elastic rubber material g can be injected into the cavity 4c of the mold 4. By doing so, as shown in FIG. 7D, the tire 1 in the present invention embedded with the elastic members 2 can be manufactured. After forming the tire by vulcanization, while separating the female mold 4a and the male mold 4b of the mold 4, the mold pins 4p of the mold 4 can be easily withdrawn from the hole 2h of the elastic member 2.

In the preceding paragraphs explanation has been given as to the ease with which the forming and manufacturing the elastic members 2 can be done in view of the structural features of the elastic member. Attention ought to be given, however, to the fact that the molding of the elastic member and the manufacture of the tire are only a part of the present invention, which is a tubeless tire embedded with elastic members. The functional advantages of the elastic members is explained below.

The tire 1 in the present invention mounted onto the rim of a bicycle wheel runs on the road as the tread 1t arranged on the tire along the circular wheel of the bicycle touches the road while one rides the bicycle. At this time, the tire 1 touches the road alternately at the portion where an elastic member is arranged and at the portion of the tire member 1a between the elastic members.

As shown in FIG. 8, when the portion of the tire with an embedded elastic member 2 touches the road, its elliptical shape is deformed by the load of the bicycle. The elastic member swiftly returns to the original shape as soon as the road-touching portion leaves the road. The major axis a of the elliptical cylinder-shaped elastic member 2 has excellent resistance to the pressure from the load of the bicycle. Thus, the portion of the tire with the elastic member 2 provides good cushion, is materially strong, has high resistance to the load, produces lesser deformation, and endures better against elastic fatigue than does the tire member 1a by itself.

Moreover, even if the load of the bicycle increases suddenly, the elastic member 2 has strong resistance in the direction of its major axis a. The through hole 2h of the elastic member 2 does not warp from pressure. The internal strength of the elastic member 2 and the elastic force of the tire member 1a surrounding the elastic member augment the elastic force firmly for each other, ensuring the safety of the tire.

When the portion of the tire member 1a between the elastic members 2 touches the road, the tire member 1a is elastically pressed by the load of the bicycle, the thickness of the sectional area of the tire member 1a decreases by the deformation of the tire member 1a, causing the side portions 1s on both sides of the tire member 1a to stick out laterally. However, the tire member 1a swiftly restores its original shape from the deformation and retains its elastic cushion as soon as it leaves the road-touching position because of its own elastic rebound and the elastic force of the elastic members combined.

At this time, if the tire member 1a had no combined construction with the elastic member 2, the tire member 1a would suffer cumulative elastic fatigue from the repetition of the process of deformation and restoration, turning flat ultimately like a plate. However, as the tire member 1a in the present invention has the elastic members 2 integrally fixed at regular intervals, the elastic members absorb part of the load when a portion of the tire member 1a is pressed by the load, preventing the tire member 1a from being pressed excessively. Moreover, in the process of the tire member recovering from the deformed position, the elastic rebound of the elastic members reinforces the restoration operation of the tire member 1a on both sides of the tire member 1a. The swift restoration of the tire member to its original shape restricts the situation where the tire member 1a is pressed again before it recovers from the deformed position, thus helping it retain good cushion, reducing the elastic fatigue of the tire member 1a, preventing the tire for turning flat like a plate, enabling the tire to be used for a long time with its original shape retained.

Besides, as shown in FIG. 3B, the middle portion c of the outer diameter d of the elastic member 2 is greater than that of its edges e, the tire member 1a and the elastic member 2 are fixed firmly, precluding the possibility of the elastic members falling out from the tire member 1a even during a high-speed riding of a bicycle, in spite of the frequently repeated deformation and restoration of the tire member, safeguarding the function of the elastic members.

Moreover, as the elastic rebound of the elastic members 2 and the elastic force of the tire member 1a are combined for mutual reinforcement, the tire retains its good elastic cushion, making the bicycle riding comfortable and pleasant. The combined mutual reinforcement of the elastic members 2 and the tire member 1a prolongs its life, reduces the need for frequent replacement of tires, and enables safe, convenient and economical use of a bicycle free from tire puncture.

While the invention has been described with reference to specific embodiments, modifications and variations of the invention may be constructed without departing from the scope of the invention, which is defined in the following claims.

I claim:

1. A tubeless tire for a bicycle wherein a multiple number of elliptical cylinder-shaped elastic members (2) are arranged and embedded at regular intervals between the bead (1d) and the tread (1t) along the circular body (1b) of the tire (1), which is made of elastic rubber or elastic synthetic resin material, in such a way that the elastic members (2) extend through both opposite sides (1s) of the tire body (1b) and wherein the major axis (a) of each of said elastic members (2), which is fixed integrally with the tire member (1a), is arranged in a radial direction toward a rotation axis of the tubeless tire (1).

2. A tubeless tire as claimed in claim 1, wherein an outer diameter (d) of a middle portion (c) of each of the elastic members (2) is larger than an outer diameter of edge portions (e) on both sides of the tire (l), wherein peripheral surfaces (2f) of the elastic members (2) slope symmetrically from the middle portions toward the edges on both sides of the tire, wherein the elastic members (2) are in the form of elliptical cylinders having elliptical through holes (2h), and wherein inner diameters (r) of the elliptical through holes (2h) expand a little from the middle portions (c) toward the edges (e) making inside perimeter surfaces (2s) of the through holes (2h) slope.

3. A tubeless tire as claimed in claim 1, wherein the elastic members (2) have peripheral surfaces, and wherein a plurality of sloping steps (2p) are provided on the peripheral surfaces (2f) to increase surface areas in order to increase firmness in fixing the elastic members (2) with the tire member (1a).

4. A tubeless tire as claimed in claim 1, wherein the elastic members (2) have through holes (2h), and wherein the through hole (2h) of the elastic members (2) embedded in the tire (1) opens through both sides (1s) of the tire body (1b).

5. A tubeless tire as claimed in claim 1, wherein the elastic members (2) are made of elastic nylon resin or elastic silicone resin compatible with the rubber or synthetic resin material of the tire (1).
